(19) United States
(12) Patent Application Publication
(10) Pub. No.: US 2019/0334255 A1
(43) Pub. Date: Oct. 31, 2019

(54) MODULAR/SCALABLE ANTENNA ARRAY DESIGN

(71) Applicant: BAE SYSTEMS Information and Electronic Systems Integration Inc., Nashua, NH (US)

(72) Inventors: Dean W. HOWARTH, Sudbury, MA (US); Corrado MANCINI, Bogota, NJ (US)

(21) Appl. No.: 15/962,091

(22) Filed: Apr. 25, 2018

(51) Int. Cl. H01Q 21/29; H01Q 21/06

(52) U.S. Cl. CPC H01Q 21/293; H01Q 21/062

(57) ABSTRACT

The system and method making and using a modular, scalable phased array antenna particularly for use on curved substrates. Surface resistors are used instead of vias to reduce the cost and to increase the configurability of the array. The array is frequency independent and can be used on flat or curved surfaces. The array can be printed as a PCB or printed using additive manufacturing.

### FIELD OF THE DISCLOSURE

The present disclosure relates to wideband phased array antennas and more particularly to making and using modular/scalable wideband antennas on shaped surfaces.

### BACKGROUND OF THE DISCLOSURE

Current phased array antennas are planar and are very expensive. In telecommunications and radar, for example, a planar array is an antenna in which all of the elements, both active and passive, are in one plane. A planar array provides a large aperture and may be used for directional beam control by varying the relative phase of each element. Dipole antennas are generally resonant at a single frequency. Connected dipole arrays obtain broadband performance through their adjoining arms.

Wherefore it is an object of the present disclosure to overcome the above-mentioned shortcomings and drawbacks associated with the conventional planar phased arrays. Here, a scalable, modular large frequency range antenna for use in a conformal configuration is described.

### SUMMARY OF THE DISCLOSURE

One aspect of the present disclosure is a system comprising a wideband radio frequency antenna array, comprising: an array face layer comprising a plurality of crossed dipole conductive elements, the plurality of crossed dipole conductive elements being arranged in rows and columns on the array face and mapped using conformal or non-conformal mapping to form a wideband radio frequency antenna array; a first dielectric core layer configured to support the plurality of crossed dipole conductive elements; a metal layer sandwiched between the first dielectric core layer and a second dielectric core layer; a conductive backend layer affixed to the second dielectric core layer, the conductive backend layer being applied to a non-conductive substrate; the array comprising a plurality of active elements and a plurality of passive elements; and a plurality of surface resistors being associated with the plurality of passive elements thus negating the need for through substrate vias associated with the plurality of passive elements.

One embodiment of the wideband radio frequency antenna array is wherein the substrate is curved. In some embodiments, the substrate comprises a printed circuit board, molded plastic, or 3D printed plastic.

In another embodiment of the wideband radio frequency antenna array, the plurality of surface resistors are located on a top surface of the array face layer. In yet another embodiment of the wideband radio frequency antenna array, the plurality of surface resistors are located on a bottom surface of the array face layer.

In some embodiments, the plurality of surface resistors comprises resistive foil, resistive conductor material, or direct print carbon loaded inks.

In certain embodiments of the wideband radio frequency antenna array, the number and location of each active and passive element is configurable to form a full up phased array. In other embodiments, the number and location of each active and passive element is configurable to form a sparse interferometer array.

In one embodiment of the wideband radio frequency antenna array, the array is mapped to the curved substrate using equal spacing mapping.

In one embodiment of the wideband radio frequency antenna array, a plurality of radio frequency connections on the backend layer are unbalanced thus requiring connection of only a single arm from each of the plurality of crossed dipole conductive elements.

In some cases, a frequency range for the antenna is from about 1 GHz to about 20 GHz. In certain cases, the wideband antenna has a frequency bandwidth of 10:1.

In still yet another embodiment of the wideband radio frequency antenna array, the plurality of crossed dipole conductive elements are printed on the array face using printed circuit board technology. In some cases, the array is formed using additive manufacturing.

Another aspect of the present disclosure is a wideband radio frequency antenna array, comprising: an array face layer comprising a plurality of crossed dipole conductive elements, each crossed dipole conductive element having a first, a second, a third, and a fourth arm, the plurality of crossed dipole conductive elements being arranged in rows and columns on the array face and mapped using conformal or non-conformal mapping to form a wideband radio frequency antenna array; a first dielectric core layer configured to support the plurality of crossed dipole conductive elements; a metal layer sandwiched between the first dielectric core layer and a second dielectric core layer; a conductive backend layer affixed to the second dielectric core layer, the conductive backend layer being applied to a non-conductive substrate; the array comprising a plurality of active elements and a plurality of passive elements; and a plurality of surface resistors being associated with the plurality of passive elements thus negating the need for through substrate vias associated with the plurality of passive elements.

One embodiment of the wideband radio frequency antenna array is wherein the antenna is only excited in V-pol.

Another embodiment of the wideband radio frequency antenna array is wherein the antenna is only excited in H-pol.

Yet another embodiment of the wideband radio frequency antenna array is wherein the antenna is excited in V-pol and H-pol. In some cases, the antenna is slant polarized. In other cases, the antenna is circularly polarized.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1A shows one embodiment of an antenna array according to the principles of the present disclosure with an eight element array highlighted.

FIG. 1B shows one embodiment of a single element of an antenna array according to the principles of the present disclosure.

FIG. 2A shows one embodiment of an antenna array according to the principles of the present disclosure with an eight element array with only V-pol highlighted.

FIG. 2B shows one embodiment of an antenna array according to the principles of the present disclosure with an eight element array with only H-pol highlighted.

FIG. 2C shows one embodiment of an antenna array according to the principles of the present disclosure with an eight element array with H-pol and V-pol highlighted.

FIG. 2D shows one embodiment of an antenna array according to the principles of the present disclosure with an eight element array with slant-pol highlighted.

FIG. 3A shows a perspective view of one embodiment of a single element unit cell of an antenna array with a balanced feed according to the principles of the present disclosure.

FIG. 3B shows a perspective view of one embodiment of a single element unit cell of an antenna array with an unbalanced feed according to the principles of the present disclosure.

FIG. 4A shows a cross-sectional view of a printed circuit board stackup of one embodiment of an antenna array according to the principles of the present disclosure.

FIG. 4B shows a cross-sectional view of a printed circuit board stackup of one embodiment of an antenna array according to the principles of the present disclosure.

FIG. 4C shows a cross-sectional view of a printed circuit board stackup of one embodiment of an antenna array according to the principles of the present disclosure.

FIG. 5A shows one embodiment of an antenna array according to the principles of the present disclosure with surface resistors.

FIG. 5B shows one embodiment of an antenna array according to the principles of the present disclosure with surface resistors.

FIG. 6A shows one possible method of mapping an antenna array onto a curved surface according to the principles the present disclosure.

FIG. 6B shows one possible method of mapping an antenna array onto a curved surface according to the principles the present disclosure.

FIG. 6C shows one embodiment of an antenna array according to the principles of the present disclosure mapped with equal spacing onto a curved surface.

FIG. 7A is a plot of predicted voltage standing wave ratios for several embodiments of the antenna array of the present disclosure.

FIG. 7B is a plot of predicted relative antenna gain for one embodiment of the antenna array of the present disclosure.

### DETAILED DESCRIPTION OF THE DISCLOSURE

In one embodiment of the present disclosure, modeling software (e.g., HFSS and Savant) along with measured data was used to design the exemplary shaped conformal structures described herein. In some cases, the designs were compared to the baseline case (i.e., a traditional flat array) to make updates in the flat configuration for later application in a curved setting.

In certain embodiments, there are multiple possible ways to manufacture the scalable, modular antennas of the present disclosure. One possible method would be to use a direct print method to apply the pattern of elements in the array to a curved substrate by printing or plating metallic conductors on dielectrics, for example. Another possible method would be to use additive manufacturing to print both the curved substrate and the pattern of metal elements of the array on the surface of the substrate at one time. Yet another possible method would be to create a pattern of metal elements of the array on a curved surface template and then peel the pattern off of the curved surface to form a flat template. The flat template could then be manufactured using traditional PCB techniques, and the like. Then, the flat printed array could be applied to a complimentary curved surface to provide a scalable, modular antenna according to the principles of the present disclosure.

A scalable radio frequency (RF) aperture is implemented by designing a wideband radiating conformal surface that can be scaled on the backend to provide configurable RF outputs such as a full up phased array or an arbitrary combination of elements to implement traditional sparse interferometer arrays to be compatible with legacy back-end processing, or the like. In certain embodiments, the RF performance can be customized in terms of frequency range, gain, polarization, and isolation by the appropriate choice of RF backed components to achieve high levels of integration. In certain embodiments, the antenna design is not shape specific; rather, it is scalable and highly reusable.

In some cases, an antenna of the present disclosure can have either vertical polarization, horizontal polarization or both. In some cases, the antenna can have slant polarization or circular polarization. Circular polarization can be either right-hand circularly polarized, RHCP, or left-hand circularly polarized, LHCP.

In certain embodiments, the radio frequency of the antenna is in the S, C, X, Ku, K, or Ka band. In certain embodiments, the frequency range is from about 2 GHz to about 20 GHz. In some embodiments, the frequency range is from about 4 GHz to about 40 GHz. In certain cases, the frequency of the antenna is in the millimeter band.

In certain embodiments, performance of the antenna over different frequency bands is dependent on dipole element size and dipole element spacing off a ground plane. In certain embodiments, the higher frequency for the overall bandwidth, the smaller the dipole unit cell and shorter the height above the ground plane.

In one embodiment, the array has two major parts: a front end and a back end. In one embodiment, the front end is independent of the ultimate use of the antenna (e.g., on what shape, for what application), while the back end is application specific. In some cases, the back end is reconfigurable (e.g., one common structure on the back side that can be customized for a particular application). In certain cases, more radiating elements may be connected to if needed. Therefore, the design is reconfigurable for each set of hardware. Configurability is important because this provides for a very inexpensive antenna that covers the same frequency range that is required by several distinct applications and helps to drive the cost of these systems down. In some cases, once the configuration is set, it cannot be changed. In other cases, the back end is reconfigurable on the fly.

In some cases, an antenna of the present disclosure has a 10:1 frequency bandwidth. This bandwidth is set by both useable gain and VSWR.

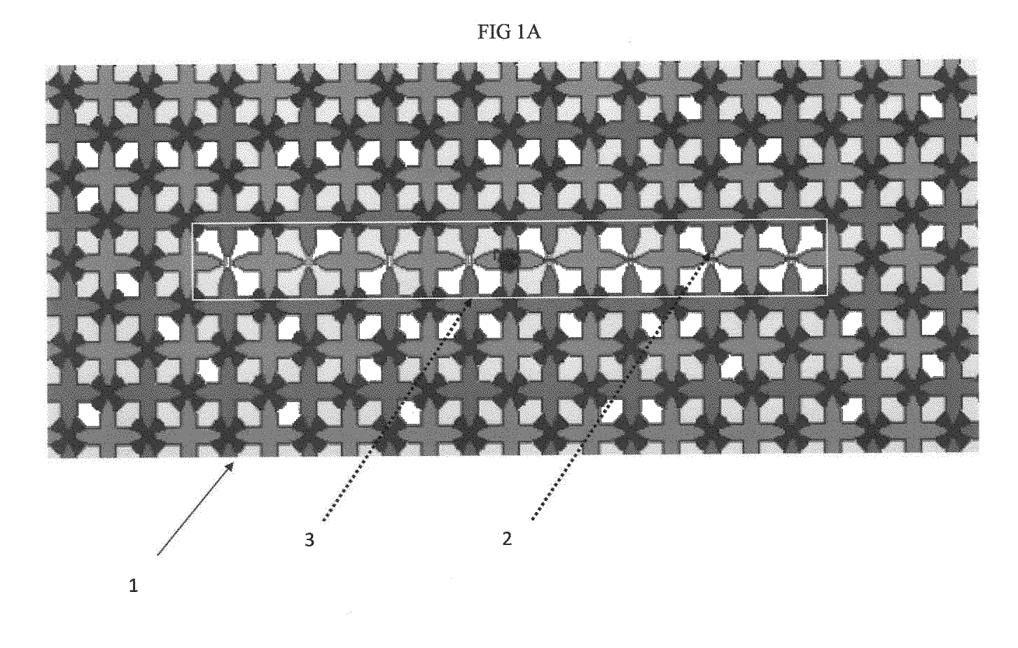

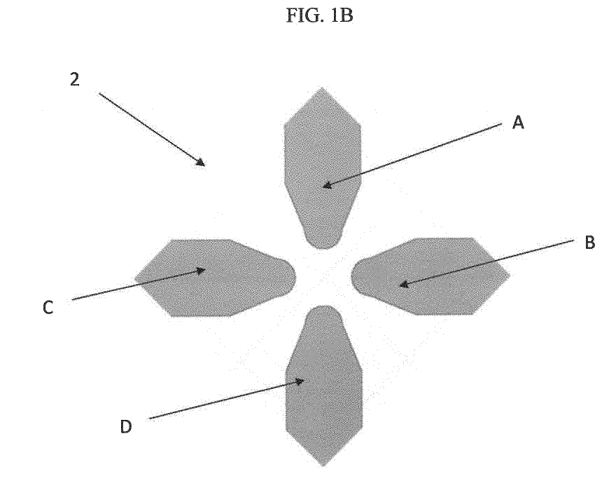

Referring to FIG. 1A, one embodiment of an antenna array according to the principles of the present disclosure is shown with an eight element array highlighted. More specifically, an array 1 is made up of a plurality of individual cross dipole elements 2, as shown in more detail in FIG. 1B, arranged in rows and columns. In one embodiment, an eight element array 3 is used. In some examples, more or fewer elements may be used for a particular application. In one example, within an array of 1000 elements, four sets of eight element arrays (i.e., 32 active elements) may be used.

In one embodiment of the present disclosure, the antenna array comprises three or more rows of passive elements surrounding each active element array (e.g. eight active elements in FIG. 1A) while retaining consistent performance. Consistent performance could include an acceptable antenna pattern shape, with gain and VSWR performance retained with three or more rows.

Referring to FIG. 1B, in certain embodiments each individual element in the array is a crossed dipole forming a first A, a second B, a third C, and a fourth D “arm.” The orientation of one element relative to the other elements in an array and the orthogonality of adjacent “arms” within a single element provides for adaptability of the array for a variety of applications and for use on a variety of curved surfaces.

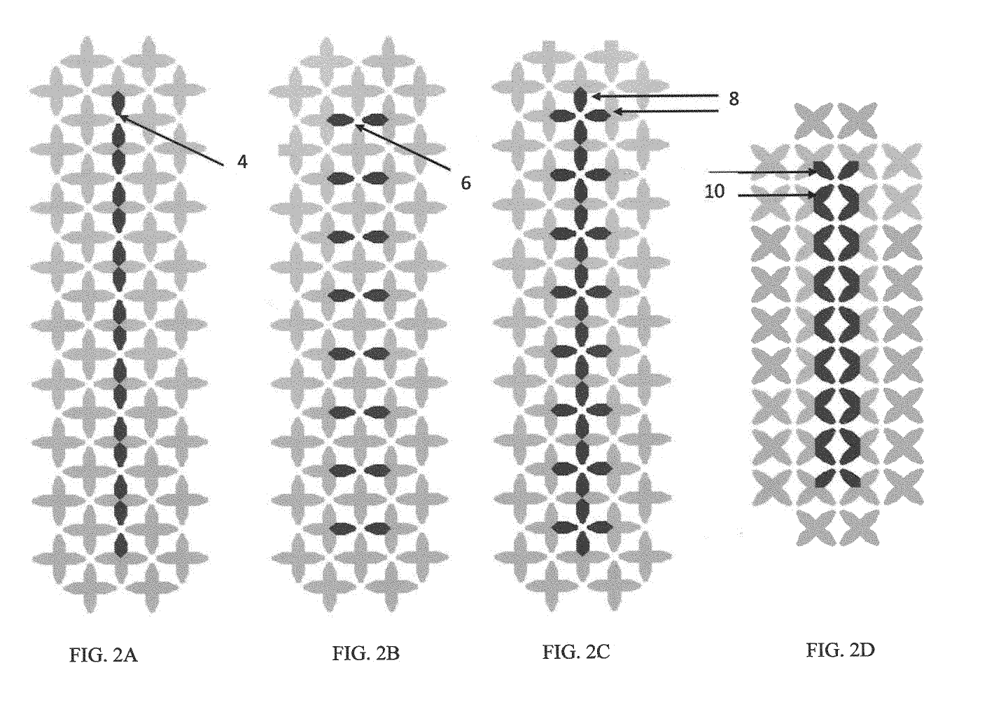

Referring to FIG. 2A, one embodiment of an antenna array according to the principles of the present disclosure is shown with an eight element array with only V-pol highlighted. More specifically, the antenna elements are configured to be excited in a number of ways. Here, V-pol only 4 was used.

Referring to FIG. 2B, one embodiment of an antenna array according to the principles of the present disclosure with an eight element array with only H-pol highlighted is shown. More specifically, the antenna elements are configured to be excited in a number of ways. Here, H-pol only 6 was used.

Referring to FIG. 2C, one embodiment of an antenna array according to the principles of the present disclosure with an eight element array with V-pol and H-pol highlighted is shown. More specifically, it is understood that varying how each “arm” of each of the antenna elements is excited creates polarization states including horizontal 6, vertical 4 and combinations thereof, such as slant 10 or circular polarized 8 depending on the application and the topology of the substrate. Here, circular polarization is possible 8 by exciting both H-pol and V-pol as is understood by those of skill in the art.

Referring to FIG. 2D, one embodiment of an antenna array according to the principles of the present disclosure with an eight element array with slant-pol highlighted is shown. More specifically, the antenna elements are configured to be excited in a number of ways. Here, slant-pol 10 was used as the antenna elements are in a different orientation. Thus, the V-pol and H-pol are being excited together.

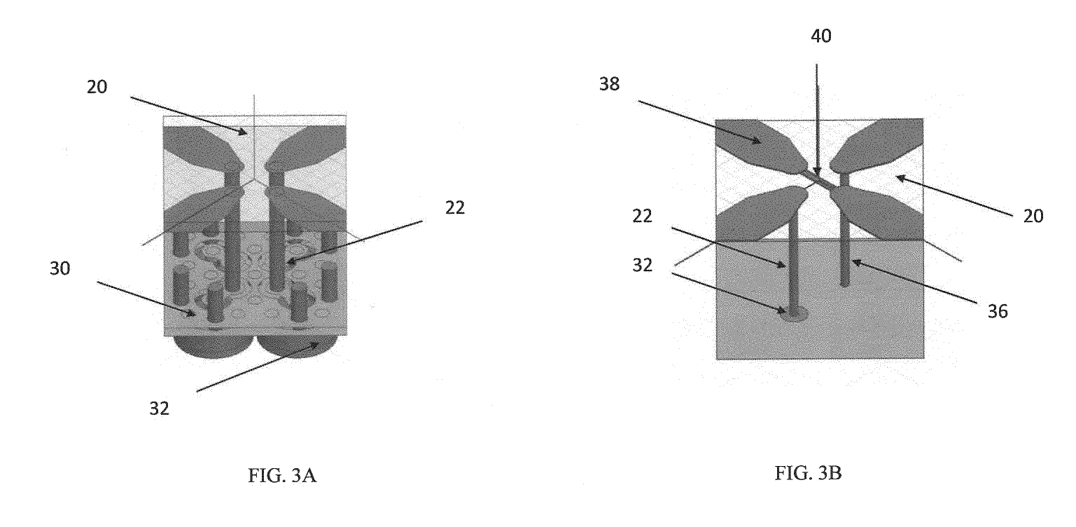

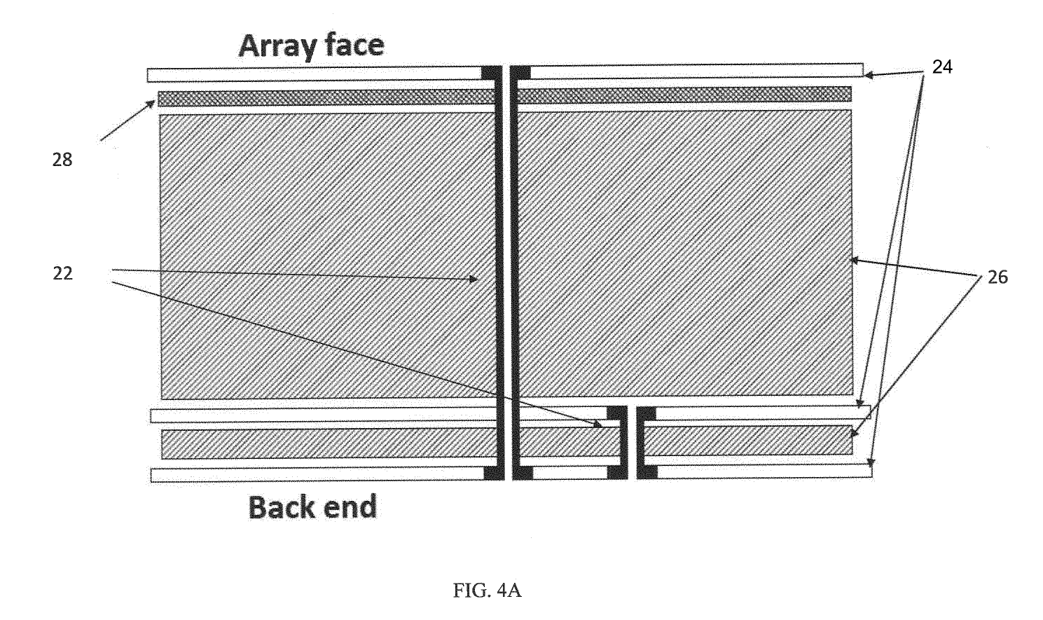

Referring to FIG. 3A, a perspective view of one embodiment of a single element unit cell of an antenna array according to the principles of the present disclosure is shown. More particularly, the array face 20 is shown with the four orthogonal conductive element “arms” on a dielectric substrate. The back end 30 is also shown connected to the array face using vias 22, e.g. plated through holes. Additionally, connectors 32 were used on the back face. In this embodiment, each arm of the crossed dipole was fed individually, as a balanced feed. In some cases, the unit cell is about 0.328″ by about 0.164″.

In one embodiment of the antenna array of the present disclosure a 180° balun is used to connect to the two connectors of the conductive element arms, exciting a balanced dipole. The use of a balun introduces insertion loss up to 2-3 dB in some cases. In some cases, an unbalanced feed is desirable for some applications and a balun would not be needed thus removing the extra loss and simplifying the backside feed structure as only one port for each active element needs to be connected to.

Referring to FIG. 3B, a perspective view of one embodiment of a single element unit cell of an antenna array according to the principles of the present disclosure is shown. More particularly, a perspective view of one embodiment of an unbalanced feed single element of an antenna array is shown. One pair of arms 38 of the crossed dipole on the array face 20 form an active element by exciting a single arm of the unbalanced feed while shorting the other arm to ground with a via 36. The orthogonal arm is a passive element and is terminated with a surface resistor 40.

Still referring to FIG. 3B, shorting vias 36 and lower dielectric constant cores can help control or mitigate unwanted common mode resonances from unbalanced feeds. Performance of an unbalanced feed and balanced feed are comparable when including the possible insertion loss caused by the use of a balun in a wideband array.

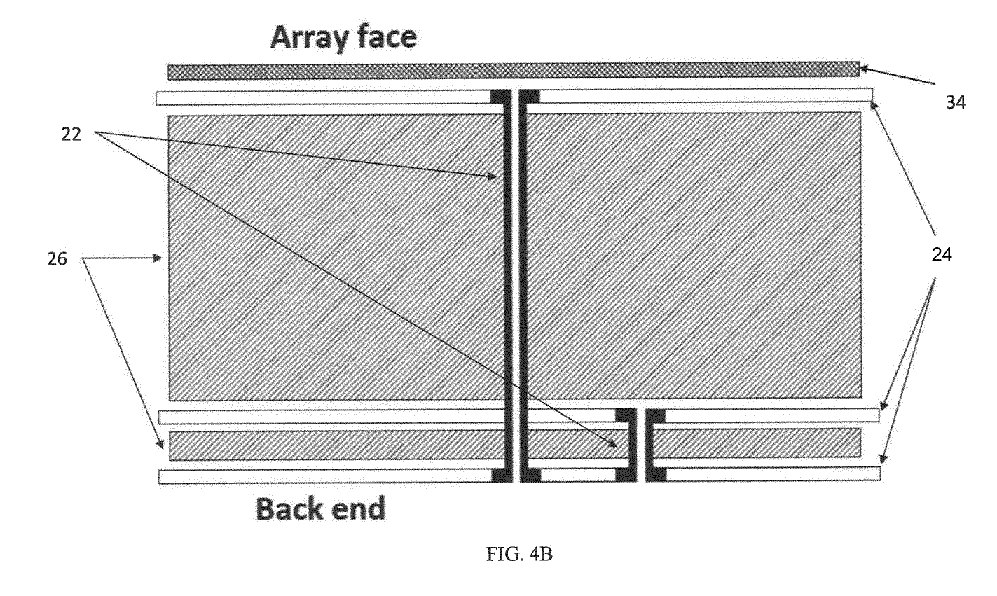

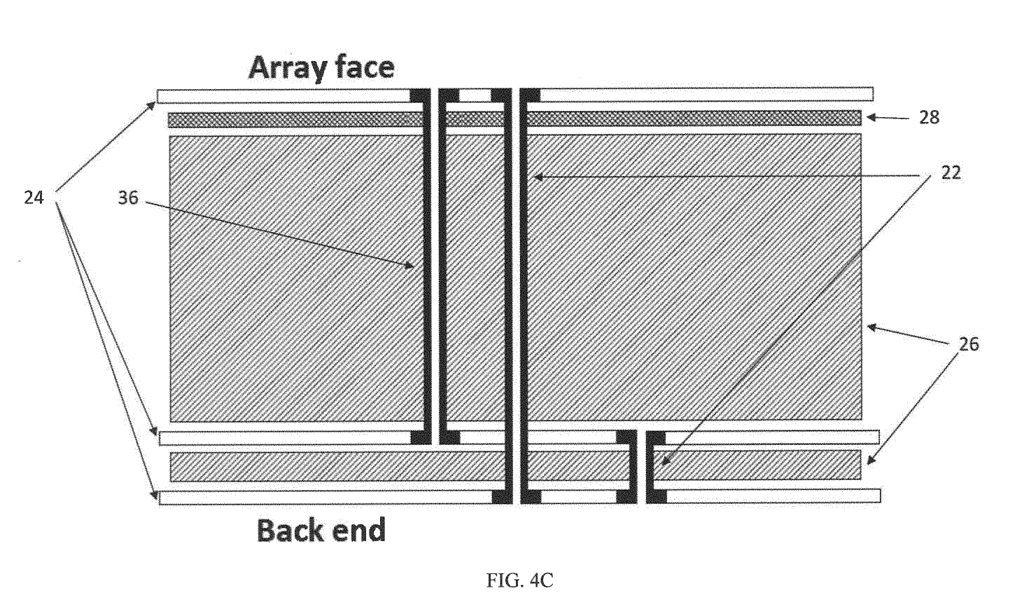

Referring to FIG. 4A, a cross-sectional view of one embodiment of a printed circuit board stackup of the antenna array according to the principles of the present disclosure is shown. More particularly, the array face is shown near the top of the figure and the back end of the array is at the bottom of the figure. In certain embodiments, the antenna array in cross section is made up of several copper layers, 24, several dielectric, core layers 26. The various copper layers are connected using plated through holes, or vias 22. In this embodiment, surface resistors 28 are located underneath the copper of the array face. In some embodiments, the surface resistors are comprised of etchable resistive foil or etchable resistive conductor material or direct print inks.

Referring to FIG. 4B, a cross-sectional view of one embodiment of a printed circuit board stackup of the antenna array with surface resistors implemented through printable resistive inks above the metal array face is shown. More specifically, the surface resistor 34 is located on top of the copper array face. The array face is shown near the top of the figure and the back end of the array is at the bottom of the figure. In certain embodiments, the antenna array in cross section is made up of several copper layers, 24, several dielectric, core layers 26. The various copper layers are connected using plated through holes, or vias 22. In some embodiments, the surface resistors are comprised of etchable resistive foil, etchable resistive conductor material, direct print inks or the like.

Referring to FIG. 4C, a cross-sectional view of one embodiment of a printed circuit board stackup of the antenna array with unbalanced feed is shown. More specifically, shorting vias 36 may be used with the unbalanced feed. The array face is shown near the top of the figure and the back end of the array is at the bottom of the figure. In certain embodiments, the antenna array in cross section is made up of several copper layers, 24, several dielectric, core layers 26. The various copper layers are connected using plated through holes, or vias 22. In this embodiment, surface resistors 28 are located underneath the copper of the array face. In some embodiments, the surface resistors are comprised of etchable resistive foil, etchable resistive conductor material, printable carbon loaded inks, or the like.

In another embodiment of the antenna array of the present disclosure, surface resistors were used to reduce the complexity inherent to a curved build. In some cases, the use of surface resistors in the receive antennas of the present disclosure, allowed for the removal of numerous vias and backside chip resistors (e.g., about 4000 vias and chip resistors in 9″×9″ design). This change made for a simpler and less expensive system that provided for consistent performance. In certain embodiments, the surface resistors comprised resistor conductor material or resistive foil. In some cases, the surface resistors comprised resistive ink. Numerous modeling iterations were conducted to vary the size and resistivity of the surface resistors while complying with the electromagnetic environment (EME) requirements for various applications such as the ones defined in MIL-STD-464C tables. It is understood that any wideband antenna used in the field will need to be able to withstand radiation exposure from other systems, such as the powerful systems used in the Naval environment.

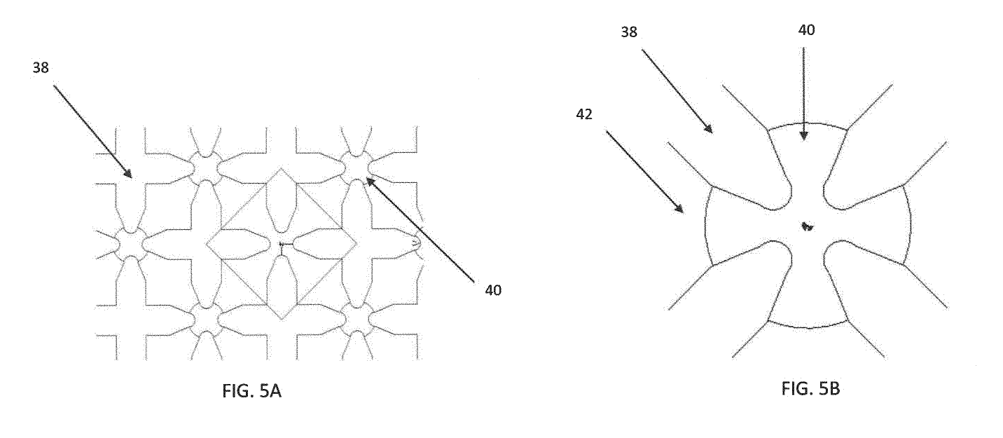

Referring to FIG. 5A, one embodiment of an antenna array according to the principles of the present disclosure with surface resistors is shown. More specifically, a series of active and passive conductive elements are located on a dielectric surface. In some cases, the conductive elements 38 are direct printed onto a substrate and in some cases the conductive elements 38 are plated or etched according to traditional PCB technologies. In certain embodiments, a rigid PCB is formed to a desired curve. In some embodiments, a thin flexible PCB is bonded to a plastic part and uses pin vias as RF connections to the backside. In some embodiments, a low dielectric constant material is preferred. In certain cases, the effective dielectric constant of a 3D printed lattice is preferred. In some cases, this provides for increased bandwidth. In some cases, this provides for decreased surface wave effects and decreased unbalanced feed common mode effects.

Still referring to FIG. 5A, a series of surface resistors 40 are present in the array. In some cases, the conductive element with the missing surface resistor is one of the active elements. In certain embodiments, this active element is electrically connected to the backside with metal vias. The square in FIG. 5A is used in this case to highlight the active element in the figure.

Referring to FIG. 5B, one embodiment of an antenna array according to the principles of the present disclosure with surface resistors is shown. More particularly, conductive elements 38 are present on a dielectric surface 42 and are interconnected with surface resistors 40. Modeling shows that the surface resistor designs have performance comparable to chip resistor backed designs. In some cases, circular resistors are used. The shape, size, and resistivity can be varied depending on the desired antenna performance. In some cases, the circular resistors are about 0.16″ in diameter and are about 100-250 Ω/sq.

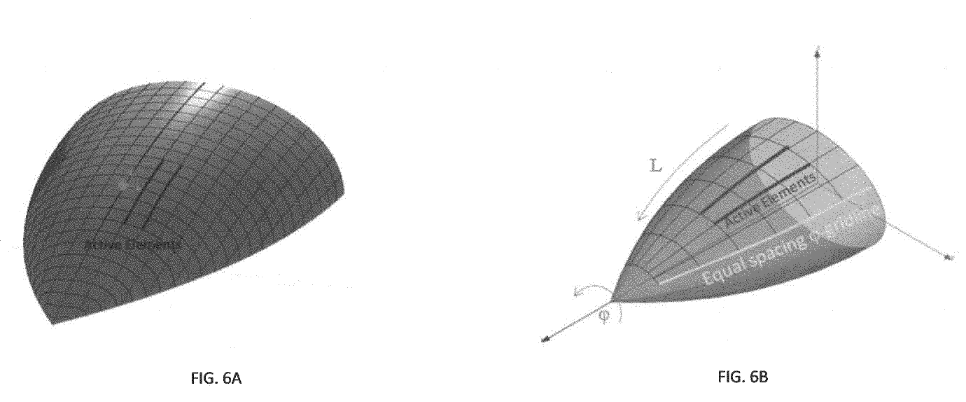

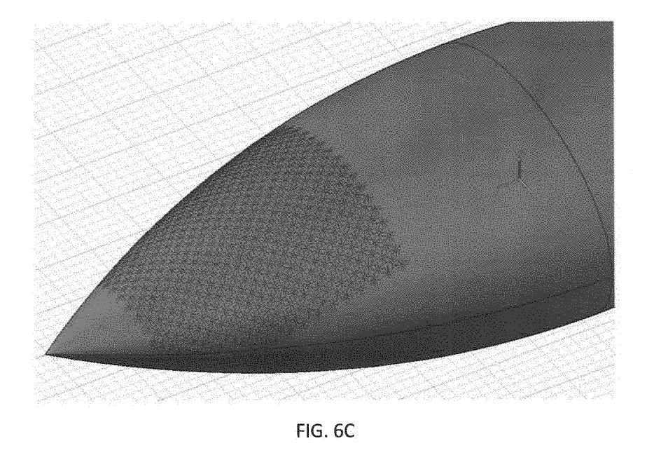

In one embodiment of the wideband antenna of the present disclosure, a modified NASA almond, a NASA “blimp,” was used to model more extreme curvature. At these levels of curvature, a 10% stretch was seen at the ends of the center line and 30-50% stretch occurred at the outer dimensions of the test antenna array when projecting the flat array onto the curved surface. Two methods of mapping the array of the present disclosure to a complex curve were used to counter this stretching. The first method was equal spacing mapping (see, FIG. 6A) a form of non-conformal mapping. This method preserves the spacing between elements, but not the angles between the elements. The second method was Phi-L mapping (see, FIG. 6B) a form of conformal mapping that preserves the angles between intersecting curves but requires that the size of individual elements and the spacing between the elements change.

Equal spacing mapping is determined by starting from a central point on the curved surface. Two orthogonal central gridlines are determined from that point. The rest of the gridlines are determined by moving a set distance along the surface perpendicular to each point on the preceding gridline. The distance along the surface is calculated from the 3D geometry of the surface:

$$‖ \vec{r} ( t ) ‖ = \sqrt{\frac{{dz}^{2}}{dt} + \frac{{dy}^{2}}{dt} + \frac{{dx}^{2}}{dt}}$$

$$s ( t ) = {\int }_{0}^{t} ‖ \vec{r} ( t ) ‖ dt$$

Equal spacing mapping as shown in FIG. 6A and FIG. 6C, preserves set spacing between all grid points along the surface of the curved platform. It is a form of non-conformal mapping as not all angles between intersecting curves of the mapped grid remain unchanged. The orthogonality of dipoles degrades off from the center point of the mapped grid. The spacing and the size of the elements, however, is preserved. The equal spacing mapping can be determined numerically.

A conformal mapping such as the Phi-L mapping as shown in FIG. 6B preserves orthogonality of crossed dipoles, across the entire grid but the spacing between elements is only preserved along the center y gridline. Active elements not along the center line will shrink or grow, not maintaining consistent size.

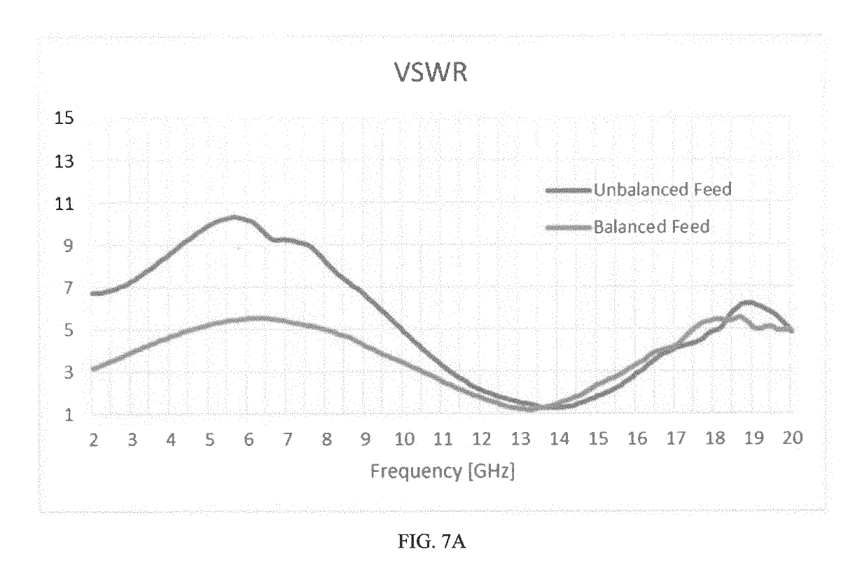

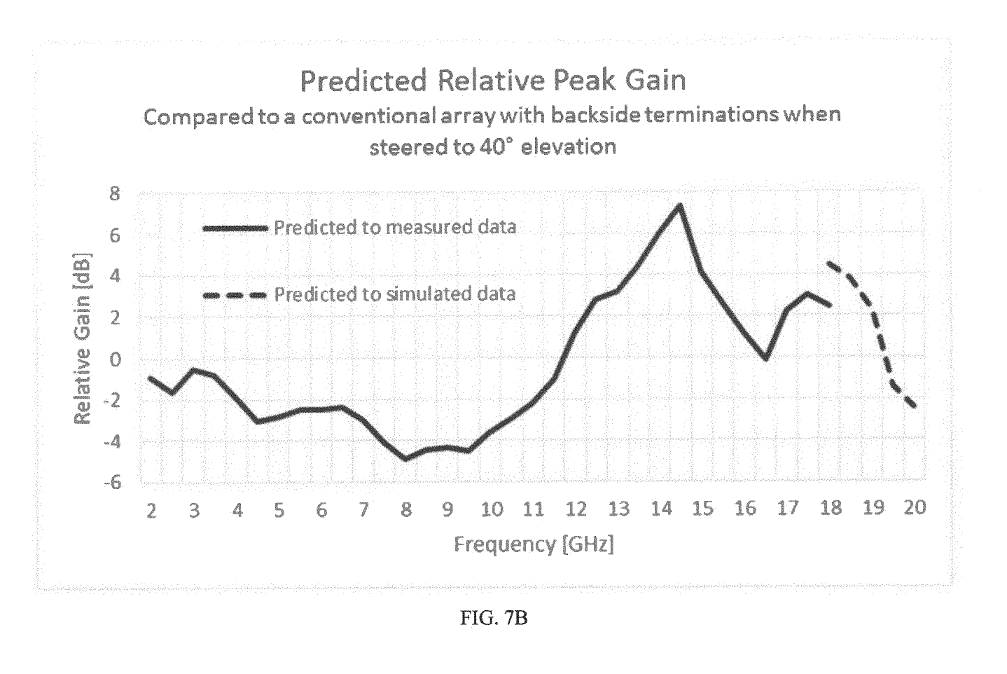

Referring to FIG. 7A, a plot of predicted voltage standing wave ratios (VSWR) for several embodiments of the antenna array of the present disclosure is shown. VSWR is a measure that numerically describes how well the antenna is impedance matched to the radio or transmission line it is connected to. VSWR of a single element of balanced and unbalanced 1×8 array is shown.

Referring to FIG. 7B a plot of predicted gain performance of one embodiment of the antenna array is shown. The plot shows relative antenna peak gain of a 1×8 active element array with passive elements terminated with surface resistors steered to 40° elevation compared to measured and simulated gain data of a conventional 1×8 active element array with passive elements terminated with backside resistors steered to 40° elevation.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A wideband radio frequency antenna array, comprising:
an array face layer comprising a plurality of crossed dipole conductive elements, the plurality of crossed dipole conductive elements being arranged in rows and columns on the array face and mapped using conformal or non-conformal mapping to form a wideband radio frequency antenna array;
a first dielectric core layer configured to support the plurality of crossed dipole conductive elements;
a metal layer sandwiched between the first dielectric core layer and a second dielectric core layer;
a conductive backend layer affixed to the second dielectric core layer, the conductive backend layer being applied to a non-conductive substrate;
the array comprising a plurality of active elements and a plurality of passive elements; and
a plurality of surface resistors being associated with the plurality of passive elements thus negating the need for through substrate vias associated with the plurality of passive elements.

2. The wideband radio frequency antenna array according to claim 1, wherein the substrate is curved.

3. The wideband radio frequency antenna array according to claim 1, wherein the substrate comprises a printed circuit board, molded plastic, or 3D printed plastic.

4. The wideband radio frequency antenna array according to claim 1, wherein the plurality of surface resistors are located on a top surface of the array face layer.

5. The wideband radio frequency antenna array according to claim 1, wherein the plurality of surface resistors comprises resistor conductor material, resistive foil, or direct print carbon loaded inks.

6. The wideband radio frequency antenna array according to claim 1, wherein the plurality of surface resistors are located on a bottom surface of the array face layer.

7. The wideband radio frequency antenna array according to claim 1, wherein the number and location of each active and passive element is configurable to form a full up phased array.

8. The wideband radio frequency antenna array according to claim 1, wherein the number and location of each active and passive element is configurable to form a sparse interferometer array.

9. The wideband radio frequency antenna array according to claim 2, wherein the array is mapped to the curved substrate using equal spacing mapping.

10. The wideband radio frequency antenna array according to claim 1, wherein a plurality of radio frequency connections on the backend layer are unbalanced thus requiring connection of only a single arm from each of the plurality of crossed dipole conductive elements.

11. The wideband radio frequency antenna array according to claim 1, wherein a frequency range for the antenna is from about 2 GHz to about 20 GHz.

12. The wideband radio frequency antenna array according to claim 1, wherein the antenna has a frequency bandwidth of 10:1.

13. The wideband radio frequency antenna array according to claim 1, wherein the plurality of crossed dipole conductive elements are printed on the array face using printed circuit board technology.

14. The wideband radio frequency antenna array according to claim 1, wherein the array is formed using additive manufacturing.

15. A wideband radio frequency antenna array, comprising:
an array face layer comprising a plurality of crossed dipole conductive elements, each crossed dipole conductive element having a first, a second, a third, and a fourth arm,
the plurality of crossed dipole conductive elements being arranged in rows and columns on the array face and mapped using conformal or non-conformal mapping to form a wideband radio frequency antenna array;
a first dielectric core layer configured to support the plurality of crossed dipole conductive elements;
a metal layer sandwiched between the first dielectric core layer and a second dielectric core layer;
a conductive backend layer affixed to the second dielectric core layer, the conductive backend layer being applied to a non-conductive substrate;
the array comprising a plurality of active elements and a plurality of passive elements; and
a plurality of surface resistors being associated with the plurality of passive elements thus negating the need for through substrate vias associated with the plurality of passive elements.

16. The wideband radio frequency antenna array according to claim 15, wherein the antenna is only excited in V-pol.

17. The wideband radio frequency antenna array according to claim 15, wherein the antenna is only excited in H-pol.

18. The wideband radio frequency antenna array according to claim 15, wherein the antenna is excited in V-pol and H-pol.

19. The wideband radio frequency antenna array according to claim 18, wherein the antenna is slant polarized.

20. The wideband radio frequency antenna array according to claim 18, wherein the antenna is circularly polarized.
